(19) United States
(12) Patent Application Publication
(10) Pub. No.: US 2010/0005703 A1
(43) Pub. Date: Jan. 14, 2010

(54) Fishhook

(76) Inventor: Robert Williams, JR., Baton Rouge, LA (US)

Correspondence Address: R. Bennett Ford, 2355 Drusilla Lane, Baton Rouge, IL, 70809, US

(21) Appl. No.: 12/217,939

(22) Filed: Jul. 10, 2008

(51) Int. Cl. A01K 83/00

(52) U.S. Cl. 43/43.16

(57) ABSTRACT

An improved fishhook for use with live bait fish in fishing operations. The fishhook comprises a unique angular configuration designed to prolong the life of live bait fish, as well as to provide for a more natural and lifelike bait presentation, to attract game fish thereto.

### BACKGROUND OF THE INVENTION

1. Field of the Invention

This invention relates to fishhooks in general and to an improved fishhook for use with live bait-fish, in particular.

2. Prior Art

Anglers often utilize different types of bait/lures in fishing operations. Live bait fish, such as minnows or the like, have an advantage over artificial lures because game fish are more likely to strike live bait and are more likely to retain live bait for a longer period of time, which in turn facilitates a successful hook-up with the game fish. The utilization of live bait is further advantageous because live bait provides for a natural and lifelike movement that is attractive to the game fish. However, several problems exist with the prior art fishhooks currently utilized with live bait. For example, a common problem associated with utilizing live bait is that many prior art fishhooks are not designed to prolong the life of such bait. In many cases, as the live bait is applied to the fishhook, the bait is either killed instantaneously or fatally injured due to the fact that damaging contact of the fishhook with the bait is unavoidable. In such scenarios, the presentation of the dead or injured bait is not lifelike, resulting in a reduced chance of a strike. In addition, many of these prior art fishhooks are often complicated in construction, thereby making it difficult for novice users to utilize them. Such fishhooks also have increased manufacturing costs due to their complexity.

Accordingly, an improvement over what is available in the prior art is desired. For these reasons, an improved fishhook meeting the following objectives would be highly desirable.

### OBJECTS OF THE INVENTION

It is an object of the invention to provide an improved fishhook that allows a prolonged bait life.

It is another object of this invention to provide an improved fishhook that allows a more natural and lifelike bait movement.

It is yet another object of the invention to provide an improved fishhook that allows a more lifelike bait presentation.

It is another object of the invention to provide an improved fishhook that increases the likelihood of a strike from a fish.

It is another object of this invention to provide an improved fishhook that is reliable, efficient, and easy to use.

Yet another object of the invention is to provide an improved fishhook that is simple in construction and thus capable of being manufactured at a reduced cost.

These and other objects of the invention shall become apparent from the ensuing figures and descriptions of the invention.

### SUMMARY OF THE INVENTION

An improved fishhook is disclosed. The preferred embodiment generally comprises an elongated shank having a straight section; a line engaging end extending from the straight section at an approximate right angle; a hook section extending from the straight section in a plane that is substantially perpendicular to the line-engaging end; wherein the hook section is offset from the straight section via a connecting section. This particular configuration of the fishhook provides for numerous advantages, including a prolonged bait life, a secure and lateral retention of the bait on the fishhook, and a natural and lifelike bait presentation.

### BRIEF DESCRIPTION OF THE FIGURES

FIG. 1 is a side perspective view of a preferred embodiment of a fishhook for use in live bait applications.

FIG. 2 is a side view of a preferred embodiment of the fishhook, depicting preferred angles, α, and β.

FIG. 2A is a side view of another preferred embodiment of the fishhook, depicting a mirror image of FIG. 2.

FIG. 2B is an end view of a preferred embodiment of the fishhook.

FIG. 3A depicts the terminal point of the fishhook about to be run through the mouth of a live bait.

FIGS. 3B depicts the terminal point of the fishhook exiting from the gill slits of the bait.

FIGS. 3C and 3D depict the head and body of the live bait being slid along the shank, towards the line-engaging end.

FIG. 3E depicts the fishhook being rotated to position the terminal point to be embedded back into the upper body of the bait.

FIG. 3F depicts the bait in its final adjusted position on the fishhook.

FIG. 4 depicts an alternative preferred embodiment of the line-engaging end of the fishhook.

### DETAILED DESCRIPTION OF THE INVENTION

An improved fishhook 1 is disclosed. Without any intent to limit the scope of this invention, reference is made to the Figures in describing the preferred embodiments of the invention.

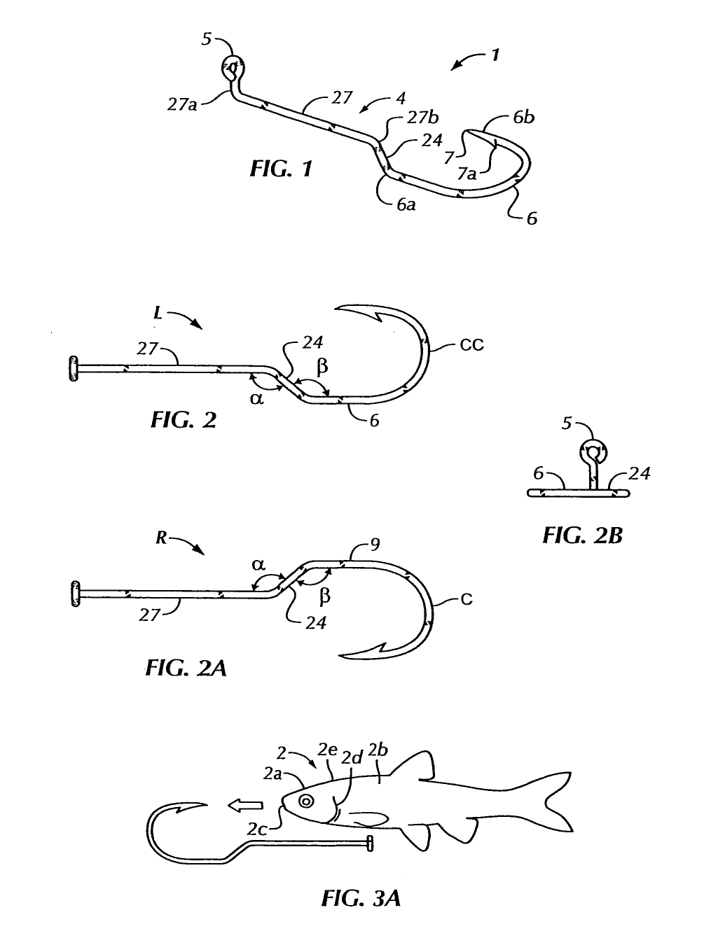

Fishhook 1 of the invention is relatively simple, yet durable, in construction. Fishhook 1 is particularly designed to be utilized in conjunction with live bait 2, such as minnows, or the like. Typical minnows comprise a head region 2a including a mouth 2c, and a body region 2b including an upper region 2e and gill slits 2d. Fishhook 1 can be designed to be of whatever size is suitable for the particular fishing situation. As depicted by FIG. 1, in a preferred embodiment, fishhook 1 comprises an elongated shank 4 of any desirable length. In constructing elongated shank 4, the inventor contemplates using metal, such as brass or steel. However, it is anticipated that various other suitable materials could also be acceptable to construct shank 4. As further depicted by FIG. 1, shank 4 comprises a straight section 27 having a first end 27a and a second end 27b. A line-engaging end 5 extends from first end 27a of straight section 27, for connection to a fishing line. As depicted by FIGS. 1 and 2B, in one preferred embodiment, line-engaging end 5 will extend from straight section 27, at an approximate right angle. As will be explained in more detail below, this particular configuration of line-engaging end 5 will facilitate a horizontal suspension of bait 2 from fishing line.

As depicted by FIG. 1, elongated shank 4 further comprises a curved hook section 6 extending from second end 27b of straight section 27. When line-engaging end 5 extends from straight section 27 at a right angle, as depicted by FIGS. 1 and 2B, it is preferred that hook section 6 be situated in a plane that is substantially perpendicular to line-engaging end 5. Hook section 6 will further have a first end 6a and a second end 6b. In a preferred embodiment, shank 4 will further comprise a connecting section 24 which will serve to offset first end 6a of hook section 6 from second end 27b of straight section 27. As will be explained in more detail below, the angular offset of hook section 6 from straight section 27 will allow the fisherman to avoid unnecessary contact of shank 4 against body 2b of bait 2, when bait 2 is applied to fishhook 1. Continuing with a preferred construction of fishhook 1, and as depicted by FIGS. 2 and 2A, connecting section 24 and straight section 27 will define an obtuse angle, α, while connecting section 24 and hook section 6 will define an obtuse angle, β. In a preferred embodiment, angle α, will be equal to angle β, with each angle preferably falling within a range of about 210 degrees to about 220 degrees.

Continuing with a discussion of a preferred construction of fishhook 1, and as depicted by FIGS. 1-4, second end 6b of hook section 6 will merge into a sharp terminal point 7, which functions to penetrate the mouth of the fish when fishhook 1 is set. Terminal point 7 may be provided with a terminal barb 7a to help retain the fish on fishhook 1. However, in general, fishhooks containing terminal barbs cause more damage to the mouths of hooked fish than fishhooks without such barbs. Thus, it may be desirable to omit terminal barb 7a, particularly when fishhook 1 is to be used in a catch and release environment.

In application, fishhook 1 comprises a left embodiment L, as depicted by FIG. 2, and a right embodiment R, as depicted by FIG. 2A. When viewing left embodiment L of fishhook 1 from above, hook section 6 will be configured in a counterclockwise direction, CC, starting from the beginning of hook section 6 and leading to terminal point 7. See, FIG. 2. In this particular embodiment, fishhook 1 will be applied to the left side of bait 2. When viewing right embodiment R of fishhook 1 from above, hook section 6 will be configured in a clockwise direction, C, starting from the beginning of hook section 6 and leading to terminal point 7. See, FIG. 2A. In this particular embodiment, fishhook 1 will be applied to the right side of bait 2.

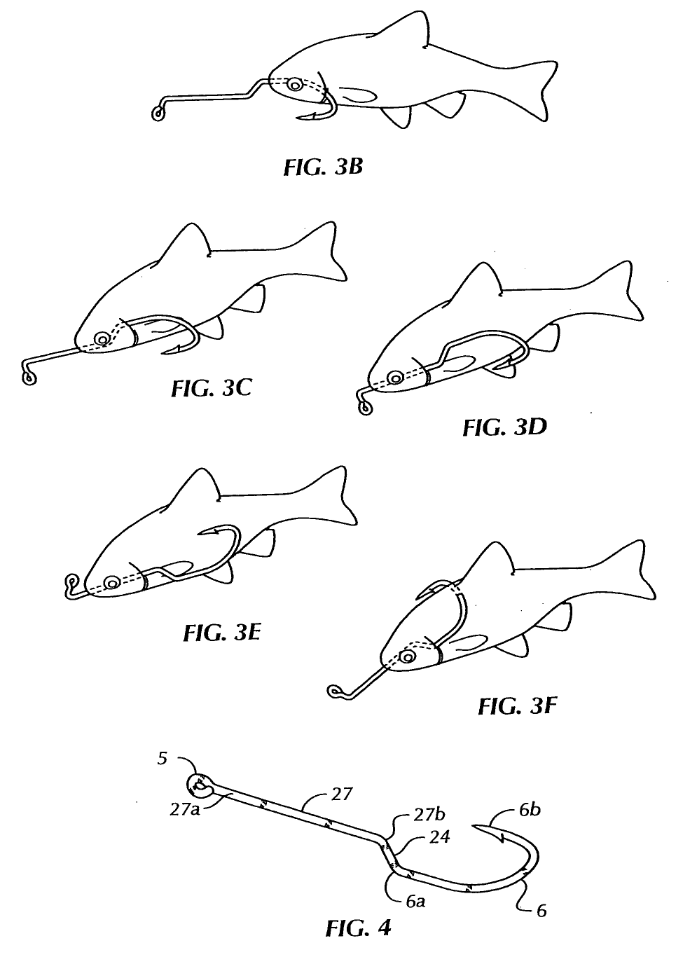

In application, and as depicted by FIGS. 3A and 3B, terminal point 7 of hook section 6 is first run through mouth 2c of live bait fish 2. Head 2a and body 2b of bait 2 are then slid along curved section 6 of fishhook 1, with terminal point 7 and terminal barb 7a, if present, subsequently exiting body 2b via gill slits 2d. In this fashion, bait 2 is applied to fishhook 1 by utilizing the natural apertures that bait 2 already possess, i.e. mouth 2c and gill slits 2d, such that fishhook 1 does not perforate bait 2 at undesired regions, making it less likely to cause death or fatal injury to bait 2. As depicted by FIGS. 3C and 3D, head 2a and body 2b of bait 2 are then passed over angular section 24 and slid along straight section 27 of shank 4, until head 2a of bait 2 is situated adjacent to line-engaging end 5 of fishhook 1. Thereafter, as depicted by FIG. 3E, fishhook 1 is rotated until terminal point 7 of hook section 6 is facing bait body 2b. The angler will then embed terminal point 7 and terminal barb 7a, if present, into body 2b of bait 2. In one preferred application, fishhook 1 may be maneuvered such that terminal point 7 and terminal barb 7a remain embedded in body 2b of bait 2. In an alternative preferred application, body 2b of bait 2 is ultimately situated so that terminal point 7 and barb 7a exit upper portion 2e of body 2b, preferably at a region that is above the spinal column of bait 2. Alternatively, terminal point 7 and barb 7a may exit body 2b at a region that is below the spinal column of bait 2, the primary objective being to avoid the spinal column and internal organs of bait 2. As terminal point 7 and barb 7a exit body 2b of bait 2, hook section 6 will angle outward from bait body 2b, due to the offset of hook section 6 from straight section 27. See, FIG. 3F, showing bait 2 in its final adjusted position on fishhook 1. This in turn allows for minimum contact of shank 4 with gill region 2d of bait 2, reducing the risk of gill injury to bait 2. Furthermore, as hook section 6 angles outward from bait body 2b, it also forces open gill slits 2d, enhancing the water and oxygen uptake of bait fish 2. In this manner, a prolonged bait life is achieved, which in turn increases the probability of a strike. Thus, the configuration of the present invention is advantageous over many prior art fishhooks, where the shank is completely straight and damaging contact of the shank with the bait's gill region is more likely, resulting in injury and/or a premature death of the bait. In such scenarios, the presentation of the dead or injured bait is not lifelike, resulting in a decreased likelihood of a strike. In one preferred embodiment of the invention, and as discussed above, a horizontal and lifelike suspension of bait 2 is further facilitated by providing fishhook 1 with a line-engaging end 5 that is situated off of straight section 26 of shank 4 at an approximate right angle. See, FIG. 1. However, line-engaging end 5 need not depend off of straight section 27 at a right angle. See, FIG. 4.

The angular offset of hook section 6, in addition to providing a prolonged bait life, as discussed above, also provides an additional advantage. In a conventional fishhook, the only pivot point is the curve situated at the base of the hook. Any upward pressure on the line will actually cause the terminal point of the hook to rotate away from the roof of the game fish's mouth, making a successful hook-up less likely. In contrast, in the current invention, hook section 6 is offset from line-engaging end 5 via connecting section 24. This creates a second pivot point. If the game fish clamps down on connecting section 24, an upward force on the line will cause hook section 6 to pivot around connecting section 24. This will drive terminal point 7 and barb 7a of fishhook 1 toward the fish's mouth, facilitating a hook-up.

It should be noted that although fishhook 1 of the invention has been discussed in the context of live bait, fishhook 1 is also capable of being utilized with a myriad of commercially available or handmade artificial lures, that can be applied to fishhook 1, either alone or in conjunction with live bait 2 in the manner commonly known in the art.

In summary, fishhook 1 of the present invention comprises a unique configuration that is inexpensive and simple in construction. Fishhook I facilitates a longer life for live bait 2, provides for a secure and lateral retention of bait 2 on the fishhook, and provides for a natural and lifelike bait 2 presentation. While the invention has been described in terms of its preferred embodiment, other embodiments will be apparent to those of skill in the art from a review of the foregoing. Those embodiments as well as the preferred embodiments are intended to be encompassed by the scope and spirit of the following claims.

I claim:

1. An improved fishhook comprising:
a. an elongated shank having a straight section;
b. the straight section having a first end and a second end;
c. a line-engaging end extending from the first end of the straight section at an approximate right angle;
d. the elongated shank further having a hook section situated in a plane that is substantially perpendicular to the line-engaging end;
e. the hook section further having a first end, a second end, and a terminal point extending from the second end of the hook section;
f. the shank further comprising a connecting section that offsets the first end of the hook section from the second end of the straight section;
g. wherein the connecting section and the straight section define an angle α;
h. wherein the connecting section and the hook section define an angle, β.

2. An improved fishhook according to claim 1, wherein angle α is approximately equal to angle β.

3. An improved fishhook according to claim 1, wherein angle α is an obtuse angle.

4. An improved fishhook according to claim 1, wherein angle β is an obtuse angle.

5. An improved fishhook according to claim 1, wherein angle α is about 210 degrees to 220 degrees.

6. An improved fishhook according to claim 1, wherein angle β is about 210 degrees to about 220 degrees.

7. An improved fishhook according to claim 1, wherein the fishhook comprises a left embodiment and a right embodiment, when the fishhook is viewed from above.

8. An improved fishhook according to claim 7, wherein in the left embodiment, the hook section comprises a beginning point and a terminal point, and wherein the fishhook is configured in a counterclockwise direction, starting from the beginning point and leading to the terminal point.

9. An improved fishhook according to claim 7, wherein in the right embodiment, the hook section comprises a beginning point and a terminal point, and wherein the fishhook is configured in a clockwise direction, starting from the beginning point and leading to the terminal point.

10. An improved fishhook comprising:
a. an elongated shank having a straight section;
b. the straight section having a first end and a second end;
c. a line-engaging end extending from the first end of the straight section;
d. the elongated shank further having a hook section;
e. the hook section further having a first end, a second end, and a terminal point extending from the second end of the hook;
f. the shank further comprising a connecting section that offsets the first end of the hook from the second end of the straight section;
g. wherein the connecting section and the straight section define an angle α,
h. wherein the connecting section and the hook section define an angle, β.

11. An improved fishhook according to claim 10, wherein angle α is an obtuse angle.

12. An improved fishhook according to claim 10, wherein angle β is an obtuse angle.

13. An improved fishhook according to claim 10, wherein angle α is equal to angle β.

14. An improved fishhook according to claim 10, wherein angle α is about 210 degrees to about 220 degrees.

15. An improved fishhook according to claim 10, wherein angle β is about 210 degrees to about 20 degrees.

16. An improved fishhook according to claim 10, wherein the fishhook comprises a left embodiment and a right embodiment, when the fishhook is viewed from above.

17. An improved fishhook according to claim 16, wherein in the left embodiment, the hook section comprises a beginning point and a terminal point, and wherein the fishhook is configured in a counterclockwise direction, starting from the beginning point and leading to the terminal point.

18. An improved fishhook according to claim 16, wherein in the right embodiment, the hook section comprises a beginning point and a terminal point, and wherein the fishhook is configured in a clockwise direction, starting from the beginning point and leading to the terminal point.
